(19) United States
(12) Patent Application Publication
(10) Pub. No.: US 2009/0084802 A1
(43) Pub. Date: Apr. 2, 2009

(54) Biased Bar-B-Q lid support assembly

(76) Inventor: Paul Joseph Nantais, Tecumseh (CA)

Correspondence Address: PAUL J. NANTAIS, 12910 JAMES CRESCENT, TECUMSEH, ON, N8N 3N3, CA

(21) Appl. No.: 11/906,315

(22) Filed: Oct. 2, 2007

(51) Int. Cl. B65D 43/24; A47J 37/07

(52) U.S. Cl. 220/744

(57) ABSTRACT

A biased Bar-B-Q lid support assembly including a mounting bracket, an assembly securing device and a support shaft having a first end and a second end. The support shaft may be locked in position by means of a biasing lever. The first end may be used to support a lid and the second end may have a handle or tab for adjusting the support shaft.

### FIELD OF THE INVENTION

This invention relates in general to supporting devices such as a Bar-B-Q Lid support and more particularly to a biased Bar-B-Q lid open support assembly.

### BACKGROUND OF THE INVENTION

There are possibly other methods available to secure or support a lid in different positions.

Thus, a lid supporting assembly which can be easily attached to or removed from the Bar-B-Q, easily adjustable to a unlimited number of open positions, the support automatically secured at a desired lid open position, where the open position is easily altered and where all this is accomplished without need of handling a hot supporting device is desirable.

### SUMMARY OF THE INVENTION

An object of one aspect of the present invention there is provided a simple means of attaching the assembly to said Bar-B-Q, an adjustable support shaft for supporting the Bar-B-Q lid and a biased locking device to retain said supporting shaft in a desired position.

Advantages of the present invention are being able to attach the assembly to the body of the Bar-B-Q, having availability to set the lid supporting shaft at various settings and not having to handle a hot support assembly every time said Bar-B-Q lid is moved.

### BRIEF DESCRIPTION OF THE DRAWINGS

A detailed description of the preferred embodiment is provided herein below by way of example only and with reference to the following drawings, in which:

FIG. 1 is a side elevation view, illustrating a Bar-B-Q lid support assembly in accordance with the preferred embodiment of the present invention;

FIG. 2 is a front elevation view further illustrating the Bar-B-Q lid support assembly in accordance with the preferred embodiment of the present invention;

FIG. 3 is a cross-sectional view taken substantially along line 3-3 of FIG. 1 showing the support shaft 2 positioned in the slide hole in mounting bracket 1 and thumb screw 6 secured against Bar-B-Q base 10.

FIG. 4 is a perspective view of the Bar-B-Q Lid Support assembly in accordance with the preferred embodiment of the present invention;

FIG. 5 is a exploded perspective view illustrating the configuration of mounting bracket 1, support shaft 2, retention lever 3 and spring 4;

FIG. 6 is a perspective view illustrating the functionality of the preferred embodiment of the present invention.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

Referring to FIG. 1 there is illustrated a side elevation view, a biased Bar-B-Q lid support assembly in accordance with the preferred embodiment of the invention. The biased Bar-B-Q lid support assembly includes a mounting bracket 1, an assembly retaining thumb screw 6, a lid support shaft 2 having a first end 8 and a second end 9 and a shaft retention lever 3 having a biasing means 4.

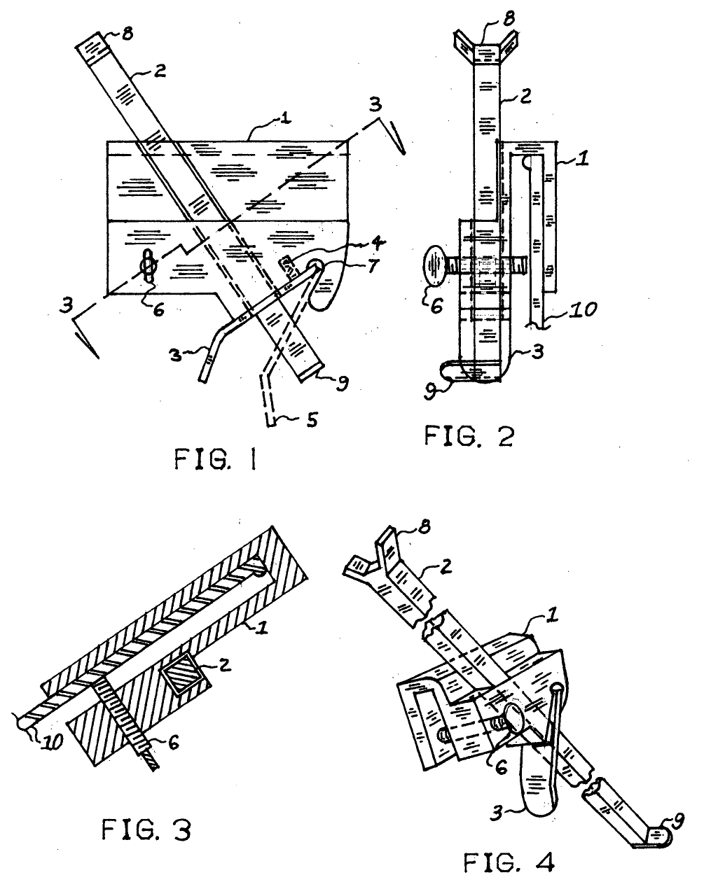

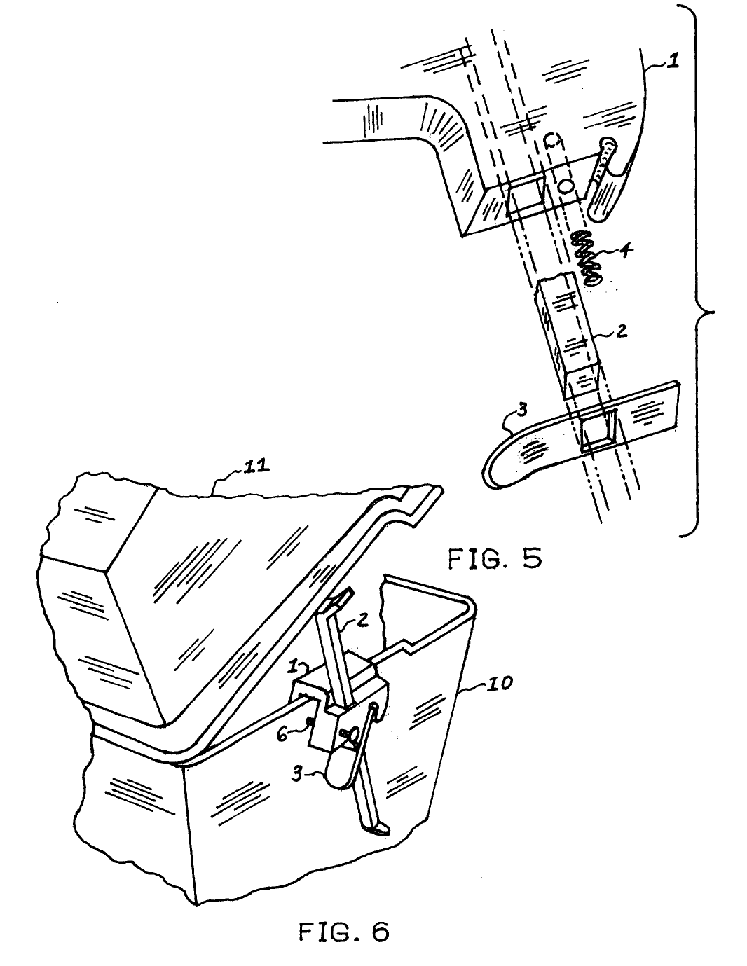

Referring to FIG. 2, the mounting bracket 1 has a slot opening for the purpose of mounting the Bar-B-Q lid support assembly on top of the side wall of the Bar-B-Q base 10. The mounting bracket 1 has a thumb screw 6 which when tightened locks the assembly in position preventing the assembly from sliding or falling off.

The lid support shaft 2 has a hook end 8 which engages and supports the Bar-B-Q lid 12 and a tab end 9 for manually adjusting the height of support shaft 2. Support shaft 2 slides up or down when the shaft retention lever 3 is pressed upwards causing the spring 4 to compress thus relieving pressure from support shaft 2. When the shaft retention lever 3, which pivots in slot 7, is released, the spring 4 biases the shaft retention lever 3 in a downward position 5 thus preventing the support shaft 2 from sliding downwards and therefore supporting the Bar-B-Q lid at the selected open position.

What is claimed is:

1. A biased Bar-B-Q lid support assembly comprising:
(a) a bracket assembly having a slot opening for mounting to a first surface
(b) a support shaft for supporting a second surface and
(c) a support shaft locking lever having a biased means;
wherein said bracket assembly is adapted for attachment to a first surface and secured by means of a thumb screw allowing said support shaft to be adjusted to support a second surface having been placed at the desired open position and the support shaft then being retained by means of a biased locking lever.

2. A Bar-B-Q lid support assembly as claimed in claim 1 wherein said support assembly is installed in an inverted position and said first end of said support shaft is adjusted in a downward direction to the said first surface.
